(19) United States
(12) Patent Application Publication
(10) Pub. No.: US 2005/0182679 A1
(43) Pub. Date: Aug. 18, 2005

(54) Bakery-cafe arranged and operated to improve customer experience

(75) Inventor: Scott McKenna, St. Louis, MO (US)

Correspondence Address: GREENBERG TRAURIG, LLP, 77 WEST WACKER DRIVE, SUITE 2500, CHICAGO, IL, 60601-1732, US

(73) Assignee: Pumpernickel Associates, LLC, Richmond Heights, MO (US)

(21) Appl. No.: 10/777,433

(22) Filed: Feb. 12, 2004

(51) Int. Cl. G06F 17/60

(52) U.S. Cl. 705/15; 705/1; 705/8; 705/9

(57) ABSTRACT

A bakery-cafe is arranged and operated in a manner that allows a customer to experience the making of artisan bread. From a customer area, the customer is able to view the mixing, shaping, and scoring of dough used in baking artisan breads, the baking of the dough, and the resulting baked artisan bread product. The mixing, shaping, and scoring of the dough occurs in a fresh dough facility that is located behind a partial-wall adjacent to the customer area. The partial-wall has a transparent portion through which activity in the fresh dough facility is generally visible. The partial-wall is further limited in height to allow conversations between a customer in the customer area and a baker within the fresh dough facility.

### BACKGROUND

This invention generally relates to bakery-cafes and, more particularly, a bakery-cafe arranged and operated to improve the customer experience.

Bakery-cafes are known in the art. For example, Panera Bread presently has cafe-bakeries that showcase the art and craft of bread making, helping customers become true bread connoisseurs through learning to identify a great loaf of bread by studying its crust, crumb and craft. To this end, certain of the current Panera Bread bakery-cafes include a customer viewable fresh dough facility in which trained bakers handcraft each loaf from scratch. While customers can view a baker mixing ingredients, hand-shaping, and hand-scoring various types of artisan breads, interaction with the baker is presently limited as the customer may only view the actions taking place in the fresh dough facility through a window that extends to the ceiling of the bakery-cafe. Accordingly, to improve the overall experience of a customer, a need exists for a bakery-cafe having a fresh dough facility design that provides customers with more accessibility to the bakers.

### SUMMARY OF THE INVENTION

The following describes a bakery-cafe which is arranged and operated in a manner that is intended to improve the overall customer experience. An appreciation of this and other objects, advantages, features, properties and relationships of such a bakery-cafe will be obtained from the following detailed description and accompanying drawings which set forth illustrative embodiments that are indicative of the various ways in which the disclosed principles may be employed.

### BRIEF DESCRIPTION OF THE DRAWINGS

For a better understanding of the disclosed system and method reference may be had to preferred embodiments shown in the following drawings in which:

FIGS. 1-3 each illustrate a floor plan of an exemplary bakery-cafe having a layout conducive to improving the customer experience.

### DETAILED DESCRIPTION

With reference to the figures, the following discloses bakery-cafes having a layout conducive to improving the customer experience by, among other things, providing a fresh dough facility that allows customers to have accessibility to the bakers, including the ability to not only watch bakers performing their craft but to also interact verbally with the bakers. While described in the context of a bakery-cafe, it is to be understood that this description is not intended to be limiting. Rather, those of ordinary skill in the art will readily appreciate how to apply the various improvements described hereinafter to other types of endeavors.

Generally, the bakery-cafes illustrated in the figures include a customer area 12 and a food preparation and food staging area 14. As will be appreciated, the customer area 12 is the area in which the customer is free to move, e.g., to order and consume purchased cafe-bakery items. Accordingly, the customer area 12 may be provided with seating and tables. Meanwhile, the food preparation and food staging area 14 is intended to be utilized only by the employees of the bakery-cafe. Various of the stations that are to be described hereinafter will also serve the function of separating the customer area 12 from the food preparation and food staging area 14.

Within with the food preparation and food staging area 14, the bakery-cafe may include one or more order entry stations 16. The order entry stations 16 are desired to be positioned adjacent to a bakery display case 18 in which is displayed baked goods of a relatively fragile nature (e.g., mini bundt cakes, cookies, muffins, brownies, croissants, danish, specialty pastries, etc.) and one or more bakery wire shelves/baskets 20 in which baked goods of a relatively more sturdy nature (e.g., artisan breads, bagels, etc.) are displayed. The wire shelves/baskets 20 are further preferably positioned along a wall (i.e., a “bread and/or bagel wall”) that is located in an area generally behind the display case 18 so as to be out of reach of, but viewable by, customers. Accordingly, baked goods displayed within the display case 18 and in the shelves/baskets of the bread/bagel wall 20 may be labeled for easy identification by the customer. For reasons that will become apparent, it may also be preferred that the order entry stations 16, the display case 18, and the bread/bagel wall 20 be positioned in an area that is in the general vicinity of an entrance, i.e., vestibule 17, to the bakery-cafe and that the baked goods within the display case 18 and the wire shelves/baskets 20 (which become readily viewable to a customer entering the bakery-cafe) be quickly accessible to an employee operating in the vicinity of an order entry station 16.

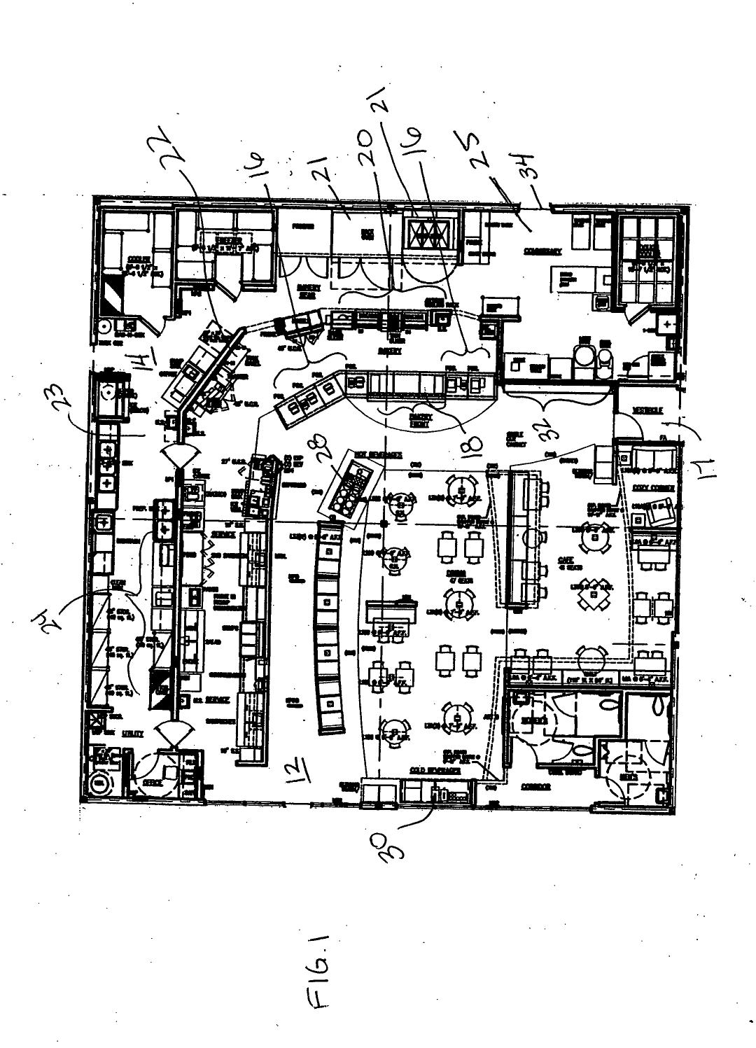

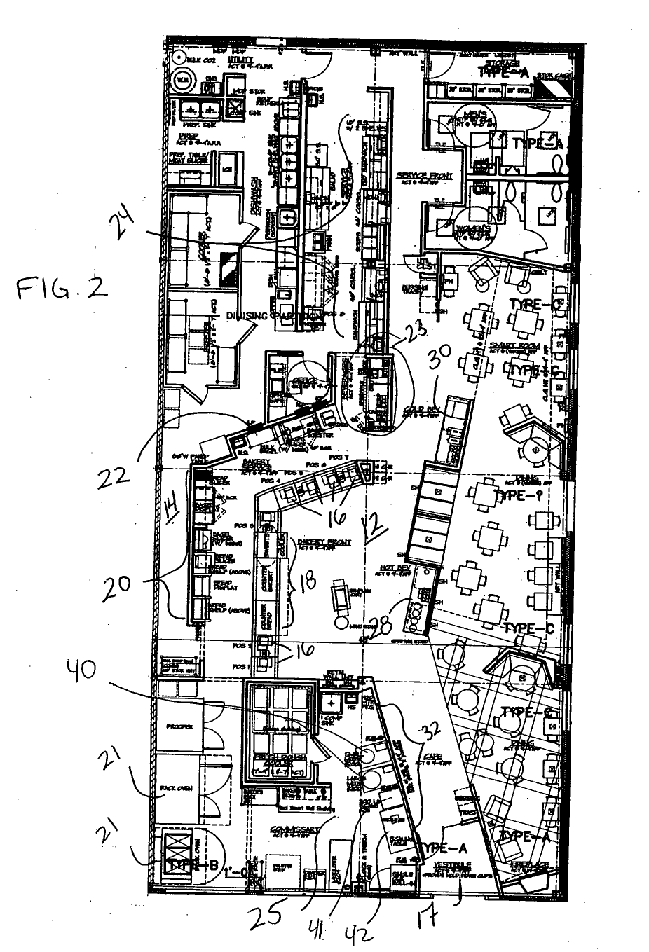

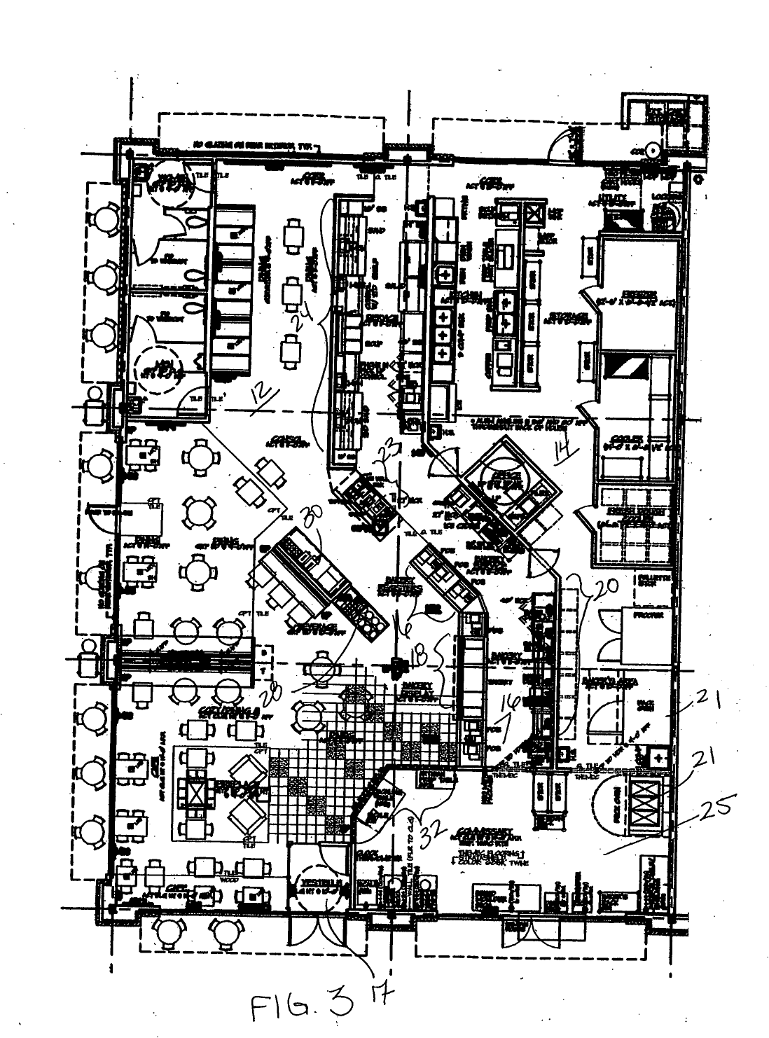

For allowing a customer to view that the baked goods, especially the artisan breads, are made fresh daily on premise, the customer is preferably provided with a view of baking ovens 21 as well as a fresh dough facility 25. The fresh dough facility 25, a part of the food preparation and food staging area 14, will be understood to be an area in which a baker mixes ingredients, hand-shapes, and hand-scores various types of artisan bread. The fresh dough facility 25 of the subject bakery-cafe preferably includes shelving on which are stored the various ingredients for making the artisan breads (e.g., flours, nuts, etc.) and one or more scales, mixers, moulders, dividers, rounders, and tables. As illustrated in FIG. 1, the baking ovens 21 may be positioned, by way of example, behind the “bread wall” and be viewable there through. Still further, as illustrated in FIGS. 2 and 3, the baking ovens 21 may be located in the customer viewable fresh dough facility 25.

Further located in the food preparation and food staging area 14 of the illustrated, exemplary bakery-cafes may be a “bulk-bagel station 22,” a beverage preparation station 23, and a food product preparation station 24 (for example, a staging area of food products utilized to prepare salad, sandwich, and/or soup ordered by a customer). The bulk-bagel station 22 is preferably provided to be accessed by an employee of the bakery-cafe, to fill bulk orders for bagels, to restock the wire shelves/baskets 20 holding bagels, etc.

The beverage preparation station 23 is illustrated as being located intermediate the bulk bagel station 22 and the food product preparation station 24. The beverage preparation station 23 is preferably provided for the purpose of fulfilling orders for specialty beverages, e.g., espresso, cappuccino, latte, tea, blended ice coffee, and/or those drinks that generally require the mixing of ingredients. While the preparation of the specialty drinks takes place in the beverage preparation station 23 of the food preparation and food staging area 14, the beverage preparation station 23 is preferably provided with a counter or the like whereby prepared beverage products may be delivered to the customer within the customer area 12. Drinks that do not need to be especially prepared, such as fountain drinks and/or coffee, may be made accessible to the customer within the customer area 12, although such drinks may be retrieved from the food preparation area 12 and delivered to the customer as part of the ordering process. Thus, by way of example, the customer area 12 may be provided with a cooler for keeping customer-accessible bottled drinks, a hot beverage filling area 28, e.g., for keeping customer-accessible coffee dispensers, and/or a customer-accessible soft drink fountain area 30. The hot beverage filing area 28 may be positioned in the vicinity of the bakery, e.g., the bakery display 18, to better serve customers during the morning rush when it is more likely that the customer will be primarily ordering only bakery items and/or hot beverages which are more likely to be taken out rather than consumed on premise.

The food product preparation station 24 is illustrated as being located at an end of the food preparation and food staging area 14 that is opposite the order entry stations 16. As noted, the food product preparation station 24 is preferably provided for the purpose of fulfilling orders for salads, sandwiches, and/or soups. To minimize the time needed to prepare salads, sandwiches, and/or soup (i.e., for serving in a bread bowl or the like), the food product preparation station 24 is further preferably positioned in the vicinity of storage areas (such as walk in refrigerators and freezers) and food pre-preparation stations (such as sinks, chopping and cutting areas, microwave ovens, toasters, etc.). In this manner, the amount of distance and, therefore, time required to stage food products for quickly preparing food product orders may be minimized.

For generally reducing customer queue times and overall congestion in the customer area in the vicinity of the food preparation area, the order entry stations 16 are preferably provided with one or more point-of-sale cash registers that are linked to one or more order printers and/or order screens that are located in the vicinity of the work stations. In a conventional manner, a customer will convey their order to a cashier manning an order entry station 16 and the cashier will, in turn, be responsible for entering the order into the combined cash register/order input system. The cash register/order input system will then calculate the total price and deliver (all or part of) the order to the order printer/order screen of an appropriate work station (22, 23, and/or 24) within the bakery-cafe for fulfillment of the order, if necessary.

To link order/customer pairs at the various work stations (22, 23, and/or 24), a reference indicia, such as a number, may be assigned to each order. This indicia may be printed on a receipt, be associated with a pager, or the like that is provided to the customer (or the customer may be verbally informed as to their assigned indicia). In this same manner, the indicia is also preferably provided to an operator of a work station (22, 23, and/or 24), for example by being printed on an order request or by being viewable on an order screen, so as to allow the operator to match food product that is to be prepared at the work station to the correct customer. It is to be appreciated that the indicia may be automatically assigned by the cash register/order input system (typically as a number assigned in a numerically increasing order) or may be manually assigned. In this regard, the indicia may be manually assigned when, for example, the customer is provided with a placard, pager, or the like having an indicia which will serve as a means for delivering prepared food product to the appropriate customer.

By way of further example, when a customer provides an order to an operator of an order entry station 16, the operator will enter the order into the cash register/order input system and charge the customer the appropriate amount. In the event that the order includes an order for baked goods that are within the display case 18 and/or wire shelves/baskets 20, an order filler, i.e., a “backer,” or the operator of the order entry station 16 may fulfill the order by retrieving the ordered baked goods from the display case 18 and/or wire shelves/baskets 20 which, as previously noted, are conveniently located in close proximity to the order entry stations 16. This order fulfillment may then be presented to the customer while the customer is at the order entry station 16. In this manner, it will be apparent that the location of baked products in the vicinity of the order entry station 16 will function to minimize queue times by minimizing food product retrieval times, especially during the morning rush when the demand for baked goods is likely to be at its highest. It will also be apparent that the location of the baked goods in an area that is readily viewable by customers in the vicinity of the entrance of the bakery-cafe will also function to minimize customer ordering time (and hence customer wait time) as customers will have an opportunity to quickly discern which baked goods are available for ordering upon entrance to the bakery-cafe.

In the event that the order includes an order for baked goods in a bulk quantity (e.g., a dozen or more), the order is preferably routed to the bulk order fulfillment station 22 where an operator of the bulk order fulfillment station 22 will be responsible for filling the order. At this time, the customer will also be directed to the bulk order fulfillment station 22 so as to receive the fulfilled order. In this manner, the current customer is efficiently removed from the ordering queue to thereby allow the next customer to place their order. Similarly, the operator of the bulk order fulfillment station 22 will be able to quickly fill the order, having bulk quantities of the pre-prepared food product readily available, to further reduce the wait time of the customer.

In the event that the order includes an order for pre-prepared beverage product (e.g., coffee, fountain drink, or bottled beverages), the customer is free to retrieve the ordered beverage at the appropriate beverage storage location (e.g., cooler 26, coffee filing area 28, and/or soft-drink fountain area 30). As noted previously, such beverages may alternatively be retrieved by a backer or order entry operator and provided to the customer. If required, the customer may be provided with the appropriate cup prior to leaving the order entry station 16. Again, it will be appreciated that allowing the customer to access pre-prepared beverage products will eliminate any wait time associated with an order entry operator retrieving the product for the customer. Furthermore, this allows the current customer to be efficiently removed from the ordering queue to thereby allow the next customer to place their order.

In the event that the order includes an order for beverage product that requires preparation by an employee of the bakery-cafe, the order is preferably routed to the beverage product fulfillment station 23 where an operator of the beverage product fulfillment station 23 will be responsible for filling the order. The customer may then move toward the beverage product order fulfillment station 23 so as to be in a position to receive the fulfilled order. As before, this method of fulfilling an order of the customer serves to efficiently remove the current customer from the ordering queue to thereby allow the next customer to place their order.

In the event that the order includes an order for food product that requires preparation, the order and customer are provided with an indicia that serves to associate the customer with the order and, while waiting for the order to be fulfilled, the customer is free to avail themselves to the beverage stations or seating as desired. In this manner, this method of providing food orders to customers functions to efficiently remove the current customer from the ordering queue to thereby allow the next customer to place their order. Similarly, since the operator of the food preparation station 24 will have food product staged for food product preparation, the operator of the food preparation station will also be able to quickly fill the order to further reduce the wait time of the customer.

From the foregoing, it is also to be understood that the arrangement of the various stations of the illustrated, exemplary bakery cafe also functions to move the customer from a first side of the bakery cafe, i.e., the area of the order entry stations 16 and entry vestibule 17, towards an opposite side of the bakery cafe with the result being a more pleasant atmosphere, e.g., it provides a bakery-cafe having relatively less customer congestion at the various stations. In the examples illustrated, the bulk order fulfillment station 22 is conveniently located in a position prior to the beverage preparation station since bulk orders for pre-prepared food products are likely to be fulfilled quicker than orders for to-be-prepared beverage products. Similarly, the beverage preparation station 23 is conveniently located in a position prior to the food preparation station 24 since it is likely that the to-be-prepared beverage orders will be fulfilled prior to the fulfillment of the to-be-prepared food order.

As noted previously, for allowing a customer to fully appreciate that the artisan breads are made from scratch and baked fresh daily, the fresh dough facility 25 is preferably viewable by a customer. In this regard, the fresh dough facility 25 is preferably viewable upon entry through the vestibule 17 to allow the customer to immediately discern that the breads and bagels that they will see in the bread/bagel racks 20 is made fresh on premise. More particularly, the fresh dough facility 25 is separated from the customer area 12 by means of a partial-wall 32 that includes a portion constructed from a transparent material, such a glass, Plexiglas or the like. Thus, the transparent material may comprise the entirety of the partial-wall 32 or may be the limited to just the upper portion of the partial-wall 32. Ideally, the partial-wall 32 is further limited in height to allow customers to talk directly to bakers working in the fresh dough facility 25 without interfering with such conversation. By way of example, the height of the partial-wall 32 may be in the range of 5 feet, plus or minus 6 to 12 inches. Still further, when the entirety of the partial-wall 32 is not constructed from a transparent material, it may be desirable to extend the transparent material downward to a level, e.g., a three foot height, where small children may observe actions taking place in the fresh dough facility 25. In some instances it may also be desirable to allow the fresh dough facility 25 to be viewed from the exterior of the cafe-bakery through a window 34. Yet further, certain of the equipment within the fresh dough facility may be positioned so as to draw the baker into an area in the vicinity of the partial-wall to further facilitate interaction between customers and the baker. By way of example, such equipment may include one or more mixers 40, a scale 41, and/or a kneading table 42 that are positioned within the fresh dough facility 25 against the partial-wall as seen in FIG. 2.

Thus has been described a bakery-cafe wherein the customer is able to experience the entirety of the artisan bread making process. While specific embodiments of such a cafe-bakery have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any equivalents thereof.

1. A method for operating a bakery cafe, comprising:
mixing, shaping, and scoring dough for use in baking artisan breads in a fresh dough facility that is positioned behind a partial-wall adjacent to a customer area, the partial-wall having a transparent portion through which the fresh dough facility is visible and being limited in height to allow conversations between a customer within the customer area and a baker operating within the fresh dough facility;
baking the artisan breads in an oven viewable from the customer area;
moving at least a portion of the baked artisan breads to a display area viewable from the customer area;
accepting an order directed to purchasing at least one of the baked artisan breads; and
fulfilling the order.

2. The method as recited in claim 1, wherein fulfilling the order comprises making a cafe sandwich using baked artisan bread.

3. The method as recited in claim 1, wherein the baked artisan bread used to make the cafe sandwich is staged at a food product preparation station.

4. The method as recited in claim 1, wherein fulfilling the order comprises making a soup bowl using baked artisan bread.

5. The method as recited in claim 1, wherein the display area comprises shelving located in an area behind an order entry station opposite the customer area.

6. The method as recited in claim 5, wherein the shelving comprises wire baskets.

7. The method as recited in claim 1, wherein the customer area comprises customer seating.

8. The method as recited in claim 1, wherein the transparent portion extends downward to a height of approximately three feet to thereby allow children to view actions within the fresh dough facility.

9. The method as recited in claim 1, wherein the fresh dough facility includes a table positioned adjacent to the partial-wall.

10. The method as recited in claim 1, wherein the fresh dough facility is located in an area adjacent to an entry vestibule of the bakery cafe.

11. The method as recited in claim 10, wherein the fresh dough facility is located intermediate the entry vestibule and the display area.

12. The method as recited in claim 1, wherein the partial-wall has a height of approximately five feet.
